(19) United States
(12) Patent Application Publication
(10) Pub. No.: US 2013/0216088 A1
(43) Pub. Date: Aug. 22, 2013

(54) ACOUSTIC MOLDED ARTICLE, SPEAKER USING SAME, AND ELECTRONIC EQUIPMENT AND MOBILE APPARATUS USING SPEAKER

(71) Applicant: Panasonic Corporation, (US)

(72) Inventor: YOSHIMICHI KAJIHARA, Mie (JP)

(73) Assignee: Panasonic Corporation, Osaka (JP)

(21) Appl. No.: 13/852,667

(22) Filed: Mar. 28, 2013

Related U.S. Application Data
(63) Continuation of application No. PCT/JP2011/005625, filed on Oct. 6, 2011.

(30) Foreign Application Priority Data
Oct. 20, 2010 (JP) 2010-235326

(51) Int. Cl. H04R 9/02; G10K 13/00

(52) U.S. Cl. CPC H04R 9/025; G10K 13/00
USPC 381/412; 524/584; 524/577; 524/612; 524/449; 524/13; 524/9; 181/199

(57) ABSTRACT

An acoustic molded article, such as a frame for a speaker, used for an acoustic instrument, includes a regenerated glass and a regenerated resin both collected from household electric appliances which have been incinerated as fuel, or used for reclamation to be discarded. Thus, this article is an environment-friendly acoustic molded article which is light, high in rigidity and internal loss, and also capable of decreasing the discharge of carbon dioxide.

### CROSS-REFERENCE TO RELATED APPLICATIONS

This is a Continuation Application of International Application No. PCT/JP2011/005625 filed on Oct. 6, 2011, which claims priority to Japanese Patent Application No. 2010-235326 filed on Oct. 20, 2010. The entire disclosures of these applications are incorporated by reference herein.

### TECHNICAL FIELD

The technical field relates to an acoustic molded article used for an acoustic instrument or an imaging instrument that may be of various kinds; and a speaker, electronic equipment such as a stereo set and a television set, and an apparatus such as an automobile.

### BACKGROUND ART

Hereinafter, a conventional speaker will be described. The conventional speaker includes a diaphragm, an edge, a voice coil, a magnetic circuit, and a frame. The voice coil is connected to a substantially central region of the diaphragm, and arranged inside a magnetic gap created in the magnetic circuit. The magnetic circuit is located at the lower portion of the frame, and the outer circumference of the edge is fixed to the upper end of the frame. The outer circumference of the diaphragm is bonded to the edge so that the diaphragm has a structure of being fixed to the frame through the edge. This frame also has a function of fixing the speaker to an instrument.

The speaker generates sounds by vibrating the diaphragm. At this time, the vibration of the diaphragm is transmitted to the frame so that the frame also vibrates. However, when the frame vibrates, the magnetic circuit also vibrates so that the acoustic property of the speaker deteriorates. It is therefore necessary that the frame does not transmit the vibration of the diaphragm to the magnetic circuit, and the frame is not resonated by the vibration transmitted to the frame.

Thus, the material used for the frame needs to be a material high not only in rigidity but also in vibrating deadening effect and internal loss effect. Accordingly, for conventional frames, a metal material or member has been mainly used, examples thereof including an iron plate, and die-cast aluminum.

However, the iron plate absorbs magnetic fluxes of the magnetic circuit so as to lower the sound pressure level of the speaker since the plate is large in magnetic leakage. Moreover, the iron plate also has a problem that the appearance is poor in high-quality feeling. The die-cast aluminum has a drawback of being very expensive although the aluminum does not cause magnetic leakage.

Thus, in order to solve these problems, frames for a speaker formed by injection-molding a thermoplastic synthetic resin have been recently increasing. In the cases, the resin alone does not give a sufficient rigidity. Thus, in order to gain a desired rigidity, a conventional frame has been obtained by molding a material in which glass fiber is added to the resin.

Prior art literatures known in the technical field are, for example, Patent Literatures 1 and 2.

### CITATION LIST

### Patent Literatures

PTL 1: Unexamined Japanese Patent Publication No. 2003-37891
PTL 2: Unexamined Japanese Patent Publication No. 2002-305783

### SUMMARY

In recent years, all industries including the household appliance industry have been emphasizing the necessity of countermeasures against global warning and the exhaustion of resources. As a result thereof, it has become essential to develop techniques capable of attaining a decrease in the discharge amount of carbon dioxide and a reduction in the use amount of petroleum resources and others, and realize speakers to which these techniques are introduced.

However, for glass fiber, and virgin resin of a basic material, a great deal of energy and petroleum resources are consumed in the production process thereof. Accordingly, the technique using these materials has a drawback that a large volume of carbon dioxide is discharged into the atmosphere.

Furthermore, a resin molded article using a material in which an inorganic filler is added to a resin generally has therein an orientation of the glass fiber, which is generated when the material is injection-molded. As a result, the resin molded article to which the glass fiber is added has a drawback that the article is high in strength property along the direction in which many pieces of the glass fiber are lined while low in strength property along the direction orthogonal to this direction.

When such a material is used to be molded into a frame, the resultant speaker comes to have, about the property thereof, many problems as described in the following. The speaker becomes small in internal loss to be decreased in effect of absorbing unnecessary vibration, and there is caused a problem that the weight of the frame is large since the specific gravity of the inorganic filler is large.

Thus, the present embodiments are provided for solving the above-mentioned problems to realize an acoustic molded article that is light and high in internal loss while keeping a high rigidity, and that makes lower a new consumption of resources and the discharge amount of carbon dioxide than acoustic molded articles for which virgin material is used. Thus, an object of the present embodiments is protecting global environment by the realization and the decrease.

In order to attain the object, the present embodiment is an acoustic molded article formed to include a regenerated glass and a regenerated resin collected from previously-used household electric appliances.

The regenerated glass is obtained by pulverizing collected glass by a pulverizer or the like. Accordingly, pulverized matters of the regenerated glass are smaller in aspect ratio than fibrous pieces of virgin glass fiber. Thus, by using such a regenerated glass to form an acoustic molded article, the molded article can be made small in physical property difference between orientations of the article. This matter makes it possible that even when the acoustic molded article suffers falling or the like, the article can undergo less deformation, breaking or some other damage.

When the regenerated material, which is collected from a previously-used household electric appliance, is used as a constituting material of the article, the discharge of carbon dioxide can also be reduced so that environment can be protected.

When regenerated glass powder is used, the acoustic molded article can be improved in internal loss. Thus, the resonance of the article is decreased and the sound pressure frequency property thereof is made flat. Furthermore, the article can decrease distortion.

### BRIEF DESCRIPTION OF THE DRAWINGS

FIG. 1 is an enlarged sectional view of a main portion of an acoustic molded article of an exemplary embodiment.

FIG. 2 is a sectional view of a speaker of an exemplary embodiment.

FIG. 3 is an external appearance view of electronic equipment of an exemplary embodiment.

FIG. 4 is a section view of a mobile apparatus of an exemplary embodiment.

### DESCRIPTION OF PREFERRED EMBODIMENTS

### First Exemplary Embodiment

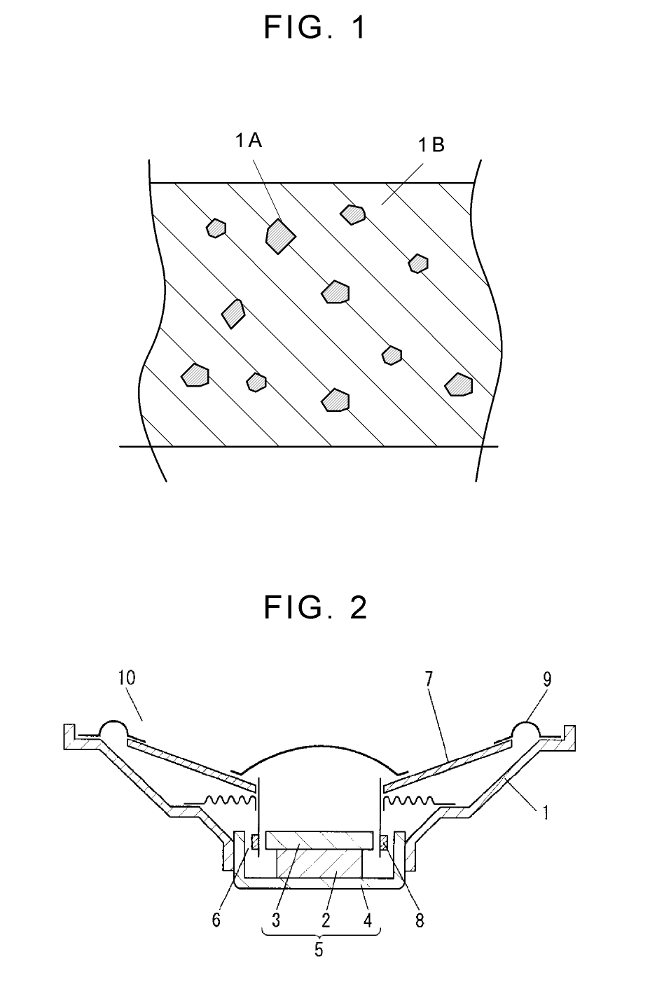

Hereinafter, exemplary embodiments will be described with reference to the drawings. FIG. 1 is an enlarged sectional view of a main portion of an acoustic molded article of an exemplary embodiment.

As illustrated in FIG. 1, the acoustic molded article of the present exemplary embodiment includes resin 1B and regenerated glass 1A. Regenerated glass 1A is obtained by pulverizing glass collected from previously-used products.

As the regenerated glass is obtained by pulverizing collected glass by a pulverizer or the like, the pulverized matters of the regenerated glass is smaller in aspect than fibrous pieces of virgin glass fiber. Thus, by using such a regenerated glass to form the acoustic molded article, the molded article can be made small in physical property difference between orientations of the article. This matter makes it possible that even when the acoustic molded article suffers falling or the like, the article can less undergo deformation, breaking or some other damage.

Furthermore, in a process for producing the acoustic molded article, the use amount of virgin material (glass) can be reduced. Accordingly, the amount of newly used fossil fuel can be made smaller than in a case wherein virgin material (glass) is used to produce an acoustic molded article. In this way, the exhaustion of finite resources can be restrained, and further the discharge of carbon dioxide can be reduced so that an acoustic molded article which can restrain environmental destruction can be realized.

Hereinafter, the structure of the present exemplary embodiment will be more specifically described. Regenerated glass 1A in the present exemplary embodiment is obtained by pulverizing glass collected from household electric appliances. Regenerated glass 1A is in the form of polyhedral particles, and the particles of regenerated glass 1A are smaller in aspect ratio than fibrous pieces of glass fiber.

Thus, even when regenerated glass 1A is added in a larger amount than when glass fiber is added thereto, the material is less lowered about the fluidity thereof when molded. Accordingly, the distribution of the pieces of regenerated glass 1A becomes more even in the resin of the acoustic molded article than in a case where glass fiber is used or added. In this way, the directivity of the strength of the material can be made small. Thus, the acoustic molded article into which this material is used to be molded becomes increased in strength. Accordingly, the obtained acoustic molded article can have large strengths such as falling-resistant strength and cracks and other damages can be decreased when the article is set to any other instrument. The material is high in elasticity; thus, the material is large in internal loss to make it possible to realize an acoustic molded article capable of improving the acoustic property of an acoustic product such as a speaker. Furthermore, the material is large in strength; thus, the acoustic molded article can be made thin accordingly. Consequently, the acoustic molded article can also be lighter.

When resin 1B is polypropylene, the acoustic molded article can be made light. Since polypropylene is large in internal loss, the resonance of the acoustic molded article can be decreased. In the present exemplary embodiment, resin 1B is polypropylene; however, this may be a polystyrene based resin, polycarbonate or some other resin.

As illustrated in FIG. 1, resin 1B used in the acoustic molded article in the present exemplary embodiment is a regenerated resin. This regenerated resin is also collected from household electric products. When the acoustic molded article has such a structure, the use amount of virgin material can be reduced in a process for producing the article. Accordingly, the use amount of newly used fossil fuel can be made smaller than in the case of using virgin material to produce an acoustic molded article. In this way, the exhaustion of finite resources can be restrained, and further the discharge of carbon dioxide can be reduced so that an acoustic molded article which can restrain environmental destruction can be realized (Materials collected from previously-used products, such as regenerated glass 1A and regenerated resin, will be generically named a regenerated material hereinafter).

The following will describe the acoustic molded article of the present exemplary embodiment in more detail, giving, as an example, frame 1 for a speaker. Frame 1 is formed by injection-molding material containing regenerated glass 1A and a regenerated resin.

The regenerated material is obtained from products collected as waste from the market. For example, a product is disassembled by hand and then thrown into a shredder to be roughly pulverized. Thereafter, the roughly pulverized materials are washed with water. In the water, the materials are further classified into individual species in accordance with a specific gravity difference therebetween. Specifically, resins smaller in specific gravity float in the water; thus, by collecting only the floating resins, the resins can be classified from other resins larger in specific gravity.

A component occupying 95% or more of the thus collected resins is polypropylene resin. However, the resin small in specific gravity to float in water includes urethane resin besides polypropylene. In other words, the collected materials include urethane resin. Thus, the collected resins are classified by wind force. According to this wind-force classification, urethane, which is lighter than polypropylene resin, is removed. This way makes it possible to give regenerated polypropylene high in purity. In the present exemplary embodiment, polypropylene having a purity of 99% or more is obtained through these processes. In order to remove urethane, urethane may be beforehand removed by wind-force classification from the roughly pulverized material. In this case, however, after the wind-force classification, the remaining material is further classified into fine particles.

Furthermore, the collected resins may be classified by use of an alcohol. Specifically, a mixed liquid having a specific gravity adjusted into the range of 0.75 to 0.80 by use of an alcohol and distilled water is prepared. The collected resins are then thrown into this mixed liquid. The specific gravity of polypropylene resin ranges from 0.9 to 0.92. Accordingly, polypropylene resin sinks into the mixed liquid. By contrast, urethane resin floats in the mixed liquid since the specific gravity of urethane resin is 0.4. Thus, only the sinking resin is taken out, so that regenerated polypropylene having a higher purity can be obtained. Of course, it is allowable to classify the collected resins beforehand into individual species by hand, and pulverize one or more of the classified resin species to yield a regenerated resin.

Japanese Home Appliance Recycling Law obliges manufacturers to collect previously-used household electric appliances. The household electric appliances to be obligatorily collected are refrigerators, air conditioners, televisions, and washing machines (as of Aug. 1, 2011).

Thus, in the present exemplary embodiment, regenerated glass 1A is obtained from cathode tube type televisions. Specifically, front glass panels of cathode tubes in televisions are pulverized, and powder of the pulverized glass is classified in accordance with the particle diameters, or the like, so that regenerated glass 1A is produced. In the present exemplary embodiment, as regenerated glass 1A, only a glass powder is used which belongs to a specific class among the classified glass powders. On the other hand, the regenerated resin is obtained by pulverizing resins collected mainly from household electric appliances such as refrigerators, air conditioners, televisions, and washing machines. According to Japanese Home Appliance Recycling Law, any manufacturer collects only products manufactured by itself. Naturally, the manufacturers understand the respective structures, used-materials, and the like the products, so that they can easily disassemble the products. The manufacturers also understand material components of the materials used in the products without making analysis and other operations onto the used-materials. Thus, they can easily classify the materials. Accordingly, regenerated material can be obtained at low costs.

In particular, in Japan, Europe and America, there have appeared flat-panel televisions, typical examples thereof including liquid crystal televisions, and change from analogue broadcast to digital broadcast has been advanced. As a result, in the market of televisions, conventional cathode tube televisions for receiving analogue broadcast have been remarkably switched to flat-panel televisions. Thus, the problem is caused that during a period for the replacement, many televisions for receiving analogue broadcast are put into the discard. Thus, by the use of regenerated material for acoustic molded articles as performed in the present application, many cathode tubes to be discarded can be effectively used as resources.

It is also assumed that in the world, an overwhelmingly large number of cathode tube televisions are still used. In other words, the discard of these cathode tube televisions would be continued hereafter. For this reason, it is very effective for restraining a future decrease in fossil fuel to recycle cathode tube televisions as resources.

As described above, the use of regenerated material makes it possible to reduce the discharge of carbon dioxide, so that acoustic molded articles which can protect environment can be realized.

Frame 1 used to be mounted into an automobile is required to be made light. Thus, as a regenerated resin, polypropylene is used. In this way, frame 1 can be made light. When polypropylene resin is used as the regenerated resin, the resonance of frame 1 can be decreased since polypropylene is large in internal loss. In the present exemplary embodiment, the regenerated resin is polypropylene. However, this regenerated resin may be, for example, polystyrene based resin or polycarbonate.

The particles of regenerated glass 1A are particles not in a needle form or spherical form but in the form of polyhedral particles. Since regenerated glass 1A is in the form of particles as described herein, the particles are evenly dispersed into the resin (polypropylene) with ease. Moreover, the particles have larger surface area contacting resin 1B than spherical particles. In this way, frame 1 can have higher rigidity than any frame in which needle-form glass fiber or spherical glass powder is used, so that frame 1 has a large internal loss and the orientation of the material thereof is also decreased. Accordingly, properties of the speaker are stabilized. Furthermore, the shape of regenerated glass 1A is an indeterminate shape, so that frame 1 does not undergo resonance easily in response to a predetermined vibration. Each of the planes of the polyhedron may be a flat plane or a curved plane.

When the particles of regenerated glass 1A have a large diameter, the particles are not evenly dispersed into resin 1B with ease. It is therefore necessary to increase the number of times of the kneading, and lengthen the period for the kneading. Accordingly, the productivity of frame 1 becomes low. Thus, it is preferable in an ordinary resin molded article containing a filler that the particle diameters (several tens of micrometers) of particles of the filler, and the distribution (several micrometers) of the particle diameters are each smaller in order to make the flowability of the resin good. However, the particles of regenerated glass 1A in the present exemplary embodiment have large diameter and particle size distribution, relatively to those of the filler particles. In short, the used particles of regenerated glass 1A are uneven in both of shape and particle diameter. The particles of regenerated glass 1A in the present exemplary embodiment are classified into particle diameters of 100 μm or less.

As described above, the particles of regenerated glass 1A are used, which contain relatively large particles and have a relatively large particle size distribution, so that the following are present in frame 1 to be mixed with each other: particles of regenerated glass 1A having relatively large particle diameters; and ones of regenerated glass 1A having relatively small particle diameters. In this way, in frame 1, resonance is not easily generated at a specified frequency. As described above, regenerated glass 1A in the present exemplary embodiment is made into the form of polyhedral particles having indeterminate shapes and having relatively large particle diameters, whereby regenerated glass 1A can realize a high productivity (good resin-flowing performance) and a high acoustic property (high internal loss).

Furthermore, it is preferable to work corners of the particles of regenerated glass 1A (into a roundish form) such that they are not pointed into acute angles, respectively. This makes it possible to make the particles of regenerated glass 1A into a state that the particles are not easily entangled with each other while resin 1B flows when the resin is molded. Thus, the resin has a good flowability when molded. Moreover, sharp corners of the particles of regenerated glass 1A can be prevented from being projected from the surface of the molded article. Accordingly, the particles of regenerated glass 1A do not cause a person to suffer a cut and other damages. Additionally, the external appearance of the molded article has no white streak of glass so as to be a far higher quality appearance than that of conventional glass fiber reinforced resin.

The following will describe the addition amount by percentage of regenerated glass 1A. The addition amount by percentage of regenerated glass 1A with respect to resin 1B is set to the range of 5% to 60% by weight, both inclusive. If the addition amount by percentage of regenerated glass 1A to resin 1B is less than 5% by weight, it is difficult to exhibit the advantageous effect of the glass. In other words, it is preferable to set the lower limit of the addition amount by percentage of regenerated glass 1A to 5% by weight in order to gain a high rigidity and a high internal loss as described above.

If the addition amount by percentage of glass fiber is large (the amount by percentage is an addition amount by percentage close to 60% by weight), a mixture of the fiber and resin 1B is deteriorated in productivity when the two are mixed with each other, or the resin is deteriorated in flowability, so that the mixture is deteriorated in moldability. However, the flowability is relatively good since regenerated glass 1A is in the form of particles in the present exemplary embodiment. Thus, even when the addition amount by percentage of regenerated glass 1A is made large, the frame is not easily declined in productivity. In this way, the addition amount by percentage of regenerated glass 1A can be made large to make frame 1 high in rigidity.

Since regenerated glass 1A is a flame retardant material, the quantity of additives for giving flame-retardancy can be made small when the addition amount by percentage of regenerated glass 1A can be increased. This matter makes it possible to reduce the use of bromine-containing or chlorine-containing agents. The use of the agents has been regulated in recent years for the protection of environment. Accordingly, materials harmful to the environment and human bodies can be decreased, and frame 1 which can further protect environment can be obtained. When regenerated glass 1A is added into a level near the upper limit of addition amount by percentage, a desired flame-retardancy can be realized with the use of no flame retardant.

However, when the flame-retardancy based on regenerated glass 1A is insufficient, a flame retardant may be further added to the glass/resin mixture. As the flame retardant, a conventional bromine-containing flame retardant can be used. When the flame retardant is ammonium polyphosphate, which is of a phosphorus-containing type, effect onto environmental destruction and human bodies can be made small. Furthermore, the flame retardant may be, for example, aluminum hydroxide, or magnesium hydroxide, which is of a metal hydroxide type.

When regenerated glass 1A is used in a state that the surface thereof is subjected to surface treatment, regenerated glass 1A becomes better in compatibility with resin 1B so that frame 1 can be improved in strength and heat resistance. A surface treatment agent used in this surface treatment is desirably a silane having a vinyl group, methacryloyl group or mercapto group.

Specific examples thereof include vinyltrimethoxysilane, vinyltriethoxysilane, 3-methacryloxypropylmethyldimethoxysilane, 3-methacryloxypropyltrimethoxyylsilane, 3-methacryloxypropylmethyldiethoxysilane, 3-methacryloxypropyltriethoxysilane, 3-mercaptopropyldimethoxysilane, and 3-mercaptopropyltrimethoxysilane.

For an alternative to the surface treatment of the glass, it is allowable to add resin/glass mixture a polypropylene obtained by acid-modifying polypropylene with an acid such as maleic anhydride. This makes it possible to make a good compatibility between the polypropylene and the glass, so that frame 1 can be improved in strength and heat resistance.

In order to improve frame 1 in strength, a reinforcing material may be added to the resin/glass mixture. The reinforcing material may be an inorganic filler or an organic filler. The inorganic filler is, for example, glass fiber, mica, talc, calcium carbonate, or zeolite. However, the filler is not limited to these materials.

The organic filler may be, for example, a bamboo material. The bamboo material may be a bamboo fiber in a beat state that the Canadian freeness thereof is 700 cc or less (the fiber will be referred to as a fibrillated bamboo fiber, hereinafter). The bamboo fiber is very light and hard. Accordingly, frame 1 can be made lighter.

Together with the fibrillated bamboo fiber, a bamboo fiber having a Canadian freeness of 5 cc or less (bamboo fiber wherein the so-called fibrillation of the fiber has been advanced) may be added to the resin/glass mixture. This bamboo fiber (referred to as the micro-fibrillated bamboo fiber hereinafter), which has a Canadian freeness of 5 cc or less, is higher in hardness. As a result thereof, frame 1 can be made far lighter and higher in rigidity. Additionally, the micro-fibrillated bamboo fiber is excellent in heat resistance. Thus, even when the use amount of the flame retardant is decreased, frame 1 can have desired flame-retardancy and an excellent heat resistance.

Instead of the fibrillated bamboo fiber, the whole of the bamboo fiber may be made into micro-fibrillated bamboo fiber. In this case, frame 1 can be further improved in heat resistance. Accordingly, frame 1 can have a desired flame retardancy even when the use amount of the flame retardant is further decreased. For example, frame 1 with no flame retardant can be realized.

In order to improve heat resistance and rigidity, bamboo charcoal obtained by carbonizing bamboo material can be used as bamboo material. It is preferable to use powder of the bamboo charcoal obtained by carbonizing bamboo at a high temperature of 800° C. or higher, and then pulverizing the carbonized bamboo. At this time, the particle diameter of the bamboo charcoal is set to 200 mm or less since a longer period is required for dispersing the bamboo charcoal as the particle diameter of the particles of the bamboo charcoal is larger.

Alternatively, bamboo powder can be used as bamboo material. Even when the bamboo powder is added to the resin, the resin is relatively high in flowability. Thus, the powder-added resin is easily molded.

When the organic filler is bamboo material and the proportion of this bamboo material is more than 50%, the frame is easily discarded by burning incineration. Thus, industrial waste can be decreased. The use of the bamboo fiber instead of glass fiber makes it possible to reduce energy consumption when the frame is produced. Additionally, bamboo is, of course, good for global environment since it is a plant which grows quickly.

By adding rubber to the regenerated resin, the impact strength can be improved.

When the regenerated resin is, for example, a styrene based resin, the addition of rubber to this styrene based resin makes it possible to yield regenerated acrylonitrile/butadiene/styrene copolymerized synthetic resin (ABS resin). The regenerated ABS resin may be used to be molded into frame 1 or the like. In this case, the regenerated resin to be used is acrylonitrile/styrene copolymerized synthetic resin (AS resin) collected from trays of refrigerators, fan rotors of air conditions and others. The regenerated ABS resin is produced by adding a butadiene rubber component and additives to the AS resin material. In the molding of the resin, material obtained by extruding the regenerated ABS resin material through an extruder, and then pelletizing the extruded matter is used.

The thus produced ABS resin is preferably used in particular for a package, such as a speaker box, for which falling-resistant strength and others are required. In such a manner, the package is made better in impact resistance and dimension precision than any package made of AS resin, so that the wall of the package can be made thinner. Accordingly, when the thus obtained ABS resin is used for, for example, a speaker frame or a speaker box for a flat-panel television, the television can be made thinner.

For a package for which impact resistance is further required, it is advisable to use polycarbonate resin as the regenerated resin. It is advisable to use regenerated polycarbonate resin obtained by pulverizing optical members such as a compact disk, as a partial volume of the polycarbonate resin.

As described above, the acoustic molded article containing regenerated glass 1A and the regenerated resin both collected from household electric appliances is used in particular desirably for a speaker frame, a speaker box, or the like. This use makes it possible to not only provide a high-performance component for a speaker by use of resources collected from previously-used products but also reduce the discharge amount of carbon dioxide to contribute to the protection of global environment.

In the present exemplary embodiment, the description has been made about frame 1 for a speaker as an example of an acoustic molded article. However, the article to which the present embodiments can be applied is not limited to this example. Thus, the same advantages can be produced even when a regenerated material is used to be molded into a different acoustic molded article. Thus, by use of a regenerating material, in particular, for a speaker box, an acoustic instrument package or the like that is made of resin, excellent acoustic properties can be realized; and further the use can contribute to the protection of global environment.

A speaker box or an acoustic instrument package is thicker than frame 1. Accordingly, even when the particle size or the particle size distribution of regenerated glass 1A is made larger, the flowability of the resin can be caused not to be lowered.

### Second Exemplary Embodiment

Hereinafter, description of a second exemplary embodiment 2 is provided. FIG. 2 is a view illustrating a cross section of speaker 10 of an exemplary embodiment.

As illustrated in FIG. 2, magnetic circuit 5 of an internally magnetic type is formed by sandwiching magnetized magnet 2 between upper plate 3 and yoke 4.

Frame 1 is bonded to yoke 4 of magnetic circuit 5. In the present exemplary embodiment, frame 1 includes a regenerated glass and a regenerated resin both collected from household electric appliances. Frame 1 in the present exemplary embodiment may be any one of the examples of frame 1 described in the first exemplary embodiment.

Edge 9 is fixed to the circumferential edge of frame 1. The outer circumference of diaphragm 7 is bonded to the inter circumference of edge 9, and the diaphragm is connected through edge 9 to frame 1.

One end of voice coil 8 is bonded to a central region of diaphragm 7. An opposite end of voice coil 8 is inserted into magnetic gap 6 of magnetic circuit 5.

In the present exemplary embodiment, the description has been made about speaker 10 having internally-magnetic-type magnetic circuit 5. However, the article to which the embodiments can be applied is not limited to this example. Thus, the article may be applied to a speaker having a magnetic circuit of an externally magnetic type.

As described in the first exemplary embodiment, according to the structure described just above, speaker 10 can be made light. Furthermore, performances of speaker 10 can be made high, for example, the sound pressure frequency property of speaker 10 can be flattened, and distortion can be decreased. Furthermore, speaker 10 about which the discharge amount of carbon dioxide can be decreased to protect global environment can be obtained. Additionally, speaker 10 having such advantageous effects can be produced and supplied with a high productivity.

These regenerated materials may be used to form diaphragm 7. In this way, the internal loss of diaphragm 7 can be made large so that divided resonance can be caused not to be easily generated. Accordingly, diaphragm 7 can have high acoustic properties. Of course, this case also contribute to environment protection.

In this case, the thickness of diaphragm 7 is very small. Thus, regenerated glass 1A having a small particle size and a small particle size distribution is used. In this way, the flowability of resin 1B is not lowered.

### Third Exemplary Embodiment

Hereinafter, description of a third exemplary embodiment is provided.

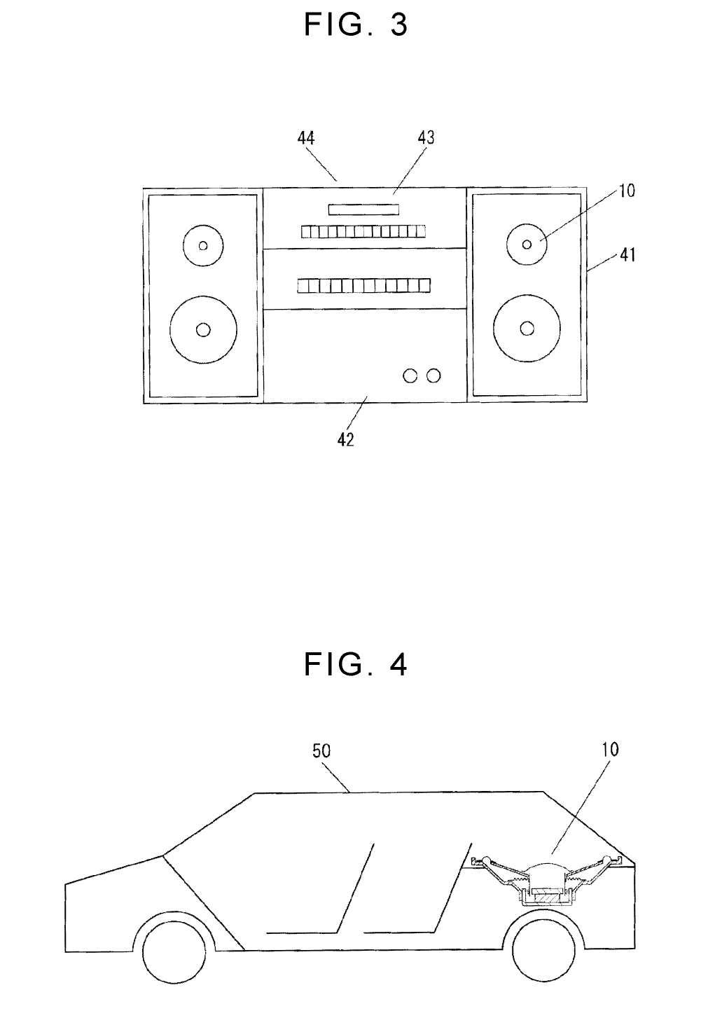

FIG. 3 is a view illustrating an external appearance of audio mini component system 44 that is electronic equipment of an exemplary embodiment.

A speaker system thereof is formed in such a manner that speaker 10 is integrated into enclosure 41 of mini component system 44.

Amplifier 42 includes an amplifying circuit for amplifying electric signals input into the speaker system. Operating section 43 includes a player and the like, and outputs sources to be input into amplifier 42.

As described above, audio mini component system 44, which is electronic equipment, includes amplifier 42, operating section 43, the speaker system, and the like.

As described in the first exemplary embodiment, frame 1 of speaker 10 includes a regenerated glass and a regenerated resin both collected from household electric appliances.

According to this structure, the speaker system can be made light. Furthermore, performances of the speaker system can be made high, for example, the sound pressure frequency property thereof can be flattened, and distortion can be decreased. Additionally, mini component system 44 makes it possible to decrease the discharge amount of carbon dioxide to protect global environment. Furthermore, mini component system 44 having such advantageous effects can be produced and supplied with a high productivity.

As an application of the speaker onto electronic equipment, the description has been made about audio mini component system 44. However, the application is not limited to this example. The speaker may be broadly applied or developed to portable audio instruments, which can be carried, imaging instruments such as a liquid crystal television and a plasma display television, telecommunication equipment such as a portable telephone, computer-related equipment, and other electronic equipment.

Furthermore, as well as frame 1, enclosure 41 of mini component system 44 is also an acoustic molded article. In the present exemplary embodiment, therefore, the speaker box, as well as frame 1, includes regenerated glass 1A and a regenerated resin both collected from household electric appliances, as described in the first exemplary embodiment. In this way, the use amount of petroleum resources can be further reduced. Thus, the present exemplary embodiment makes it possible to reduce the discharge amount of carbon dioxide to contribute further to the protection of global environment. Furthermore, the exemplary embodiment makes it possible to form enclosure 41 larger in internal loss to provide a high-performance acoustic instrument.

### Fourth Exemplary Embodiment

Hereinafter, description of a fourth exemplary embodiment is provided.

FIG. 4 is a view illustrating a cross section of car 50 of an exemplary embodiment, which is a mobile apparatus. Car 50 includes an exterior, an interior, a chassis, a driving unit mounted on this chassis, and tires connected to this driving unit.

As illustrated in FIG. 4, the mobile apparatus of the present exemplary embodiment is formed in such a manner that speaker 10 is integrated into the interior of car 50 such as a rear tray and a front panel. Speaker 10 constitutes a part of a car navigation system, a car audio system, or a different apparatus of the car. Specifically, the car navigation system, the car audio system, or the different apparatus of the car has an amplifier for amplifying source signals. Signals amplified by this amplifier are supplied to input terminals of speaker 10, and then output as sounds from speaker 10.

As described in the first exemplary embodiment, the frame of speaker 10 includes regenerated glass 14 and a regenerated resin both collected from household electric appliances.

According to this structure, car 50 or some other mobile apparatus in which speaker 10 is mounted can be made light. Moreover, the sound pressure frequency property of speaker 10 can be flattened, and distortion can be decreased. Thus, when a person rides in the mobile apparatus, the person can listen to music with a good sound quality. Furthermore, the discharge amount of carbon dioxide can be decreased. Thus, the present exemplary embodiment makes it possible to give a car or some other mobile apparatus that can protect global environment.

The frame for a speaker, and the speaker according to the present embodiments have advantageous effects of being made small in weight, flattening the sound pressure frequency property, decreasing distortion, making other performances high, and decreasing the discharge amount of carbon dioxide, and have other advantageous effects. For example, the frame and speaker may each be applied, in particular, to acoustic instruments, imaging instruments, electronic equipment such as telecommunication equipment, and mobile apparatuses for which the performance of protecting global environment is required.

What is claimed is:

1. An acoustic molded article comprising:
a glass; and
a resin,
wherein the glass is a regenerated glass including pulverized glass from a previously-used product.

2. The acoustic molded article according to claim 1, wherein the regenerated glass is in a form of polyhedral particles.

3. The acoustic molded article according to claim 2, wherein a shape of the regenerated glass is indeterminate.

4. The acoustic molded article according to claim 1, wherein the regenerated glass is collected from a previously-used household electric appliance.

5. The acoustic molded article according to claim 4, wherein the regenerated glass is produced by pulverizing a front glass panel of a cathode-ray tube of a cathode-ray tube television.

6. The acoustic molded article according to claim 5, wherein the resin is a regenerated resin collected from a household electric appliance.

7. The acoustic molded article according to claim 6, wherein the regenerated resin is a resin collected from at least one selected from a following group: a refrigerator, an air conditioner, a television, and a washing machine.

8. The acoustic molded article according to claim 7, wherein the regenerated resin is polypropylene.

9. The acoustic molded article according to claim 7, wherein the regenerated resin is polystyrene.

10. The acoustic molded article according to claim 6, wherein the regenerated resin is polycarbonate collected from an optical member.

11. The acoustic molded article according to claim 1, wherein the acoustic molded article is a speaker frame.

12. The acoustic molded article according to claim 1, wherein the acoustic molded article is a speaker box.

13. The acoustic molded article according to claim 1, further comprising a reinforcing material.

14. The acoustic molded article according to claim 13, wherein the reinforcing material is at least one selected from a following group: mica, glass fiber, and a bamboo material.

15. The acoustic molded article according to claim 14, wherein the reinforcing material includes the bamboo material, and wherein the bamboo material is a bamboo fiber.

16. The acoustic molded article according to claim 15, wherein the bamboo fiber has a beating degree of 700 cc or less defined as Canadian freeness.

17. The acoustic molded article according to claim 16, wherein the bamboo fiber comprises not only the bamboo fiber, which has the beating degree of 700 cc or less, but also a bamboo fiber having a beating degree of 5 cc or less defined as Canadian freeness.

18. The acoustic molded article according to claim 15, wherein the bamboo fiber has a beating degree of 5 cc or less defined as Canadian freeness.

19. The acoustic molded article according to claim 14, wherein the reinforcing material includes the bamboo material, and the bamboo material is bamboo charcoal obtained by carbonizing bamboo.

20. The acoustic molded article according to claim 14, wherein the reinforcing material includes the bamboo material, and the bamboo material is bamboo powder.

21. A speaker comprising:
a magnetic circuit;
a speaker frame bonded to the magnetic circuit and having an outer circumferential region;
a diaphragm bonded to the outer circumferential region of the speaker frame; and
a voice coil bonded to the diaphragm and partially disposed inside an active range of magnetic fluxes generated from the magnetic circuit;
wherein the speaker frame comprises a resin and a glass, and the glass is a regenerated glass including pulverized glass from a previously-used product.

22. An electronic equipment comprising:
the speaker according to claim 21; and
a circuit configured to amplify an input signal to be supplied to the speaker.

23. A mobile apparatus comprising an interior region to which the speaker according to claim 21 is mounted.

24. A method for manufacturing an acoustic molded article, the method comprising:
pulverizing a previously-used product to form a regenerated glass;
distributing the regenerated glass in a resin to prepare a mixture; and
molding the mixture into the acoustic molded article.
